(19) United States
(12) Patent Application Publication
(10) Pub. No.: US 2015/0338559 A1
(43) Pub. Date: Nov. 26, 2015

(54) Frontal Aperture Stop for IR Optics

(71) Applicant: UMICORE, Brussels (BE)

(72) Inventors: Tom KREKELS, Olen (BE); Bergeron SALETHAIYAN, Bergeron (BE); Paul VERVOORT, Herentals (BE)

(21) Appl. No.: 14/654,854

(22) PCT Filed: Dec. 20, 2013
(86) PCT No.: PCT/EP2013/077578

§ 371 Date: Jun. 23, 2015

(30) Foreign Application Priority Data
Dec. 28, 2012 (EP) 12199680.5

(51) Int. Cl. G02B 5/00; G02B 13/00

(52) U.S. Cl. CPC G02B 5/005; G02B 13/008

(57) ABSTRACT

An IR imaging system is presented comprising an optical assembly comprising an optical assembly with a lens housing made of an organic polymer, the housing structurally defining a frontal aperture stop having an object-side surface and a detector-side surface, characterized in that the aperture stop comprises a metallic diaphragm. This results in an affordable design, well suited to be build into portable or mobile devices, in particular when protected behind an IR-transparent window.

The present invention concerns an IR (infrared) imaging system for use in applications that combine high volumes and low costs. Amongst others, these applications could be portable devices such as thermography cameras, or could be fixed or vehicle-mounted devices for safety, security and comfort control. Optical solutions for such applications needs to be compact and low-cost, yet deliver adequate performance.

To keep the mass production costs as low as possible, the lens housing should preferably be made of polymer instead of metal. Although the thermal and mechanical stability could be an issue, the relatively modest performances of affordable IR detectors do not impose criteria that could not be met using polymers.

One of the most attractive optical designs leads to the use of a frontal aperture stop. Such a stop is an important element as it actively participates in enhancing the transfer function of the system. The integration of the frontal aperture stop with the lens housing would therefore appear to be appealing. This could be realized by extending the lens housing object-side, beyond the first lens of the optical system, and by providing the required annular restriction.

However, many of the polymers suitable for making such an integrated lens housing and aperture stop are, to some degree, transparent to IR, in particular to the long wavelength IR used in thermal imaging. For example, a 250 μm polyethylene sheet is about 75% transparent at most wavelengths between 2 and 16 μm, except for a few wavelengths at which strong absorption bands exist. As the relevant edge of the aperture stop needs to be thin, such a significant transparency of the material will degrade the effect of the stop to an undesirable degree.

Integrating a polymer-only frontal aperture stop with the lens housing would therefore not be effective.

This problem can be solved by an IR imaging system comprising an optical assembly with a lens housing made of an organic polymer, the housing structurally defining a frontal aperture stop having an object-side surface and a detector-side surface, characterized in that the aperture stop comprises a metallic diaphragm.

According to this embodiment, the lens housing is extended beyond the first lens of the optical assembly, providing an annular restriction as a supporting structure for a metallic diaphragm. This metallic diaphragm actually performs the optical function of an aperture stop.

The lens housing and frontal stop may form an integral part, i.e. manufactured in one piece using the same organic polymer throughout.

The metallic diaphragm, if of adequate thickness, will easily accomplish its intended function by effectively blocking the transmission of any IR radiation. The metallic diaphragm may consist of a metallic layer on the polymer structure defining the aperture stop, either on its object-side surface or on its detector-side surface. It may also be partially or fully embedded in the polymer structure. Due to its extreme thinness, the metallic diaphragm will typically need at least one-sided support over its complete surface.

The optical assembly must be sufficiently rugged to be mounted in e.g. a portable device. A protective barrier is therefore useful between the external world and the assembly. A possible embodiment comprises an essentially flat IR-transparent window in front of the optical assembly as a protective screen. This window could consist of silicon, and could be mounted flush with the external casing of the device.

This window is however susceptible to reflect back into the optics any IR radiation that was first reflected by the diaphragm. This will create ghost images or other undesired artifacts, in particular if the diaphragm generates specular reflections.

To solve the above problem, an IR imaging system is disclosed characterized in that the metallic diaphragm is patterned on at least its object-side surface so as to attenuate specular reflections.

It should be noted that some of the above embodiments also contribute to the reduction of specular reflections, even without the patterning of the object-side surface of the metallic diaphragm. Indeed, any layer of polymer in front of the stop attenuates both the inbound and the outbound radiation that may be reflected by the metallic stop. This effect contributes to the suppression of ghost images.

The metal can then be chosen to be relatively thin, as long as it will block IR radiation. The necessary thickness is a known or readily determined in function of the metal chosen and of the wavelength to be blocked.

A metallic layer can be deposited on the polymer surface according to known techniques.

According to a chemical process, the surface to be coated is etched, activated, electroless coated with e.g. nickel, and finally electroplated with the intended metal. Other processes such as vacuum metallization or spraying can be envisaged. Many different metals or metal-bearing compounds are suitable, as long as the composition and the thickness of the coating layer prevent the transmission of IR radiation. Any residual transmission of IR radiation is easily measurable using state of the art apparatus.

If the metallic layer is on the object-side of the stop, specular reflections can be essentially eliminated e.g. by grooves or other three-dimensional patterns on the object-side of stop, made either before or after the metallic layer is applied. The depth of the pattern or grooves can be optimized in known ways to eliminate or at least to attenuate specular and non non-specular reflections.

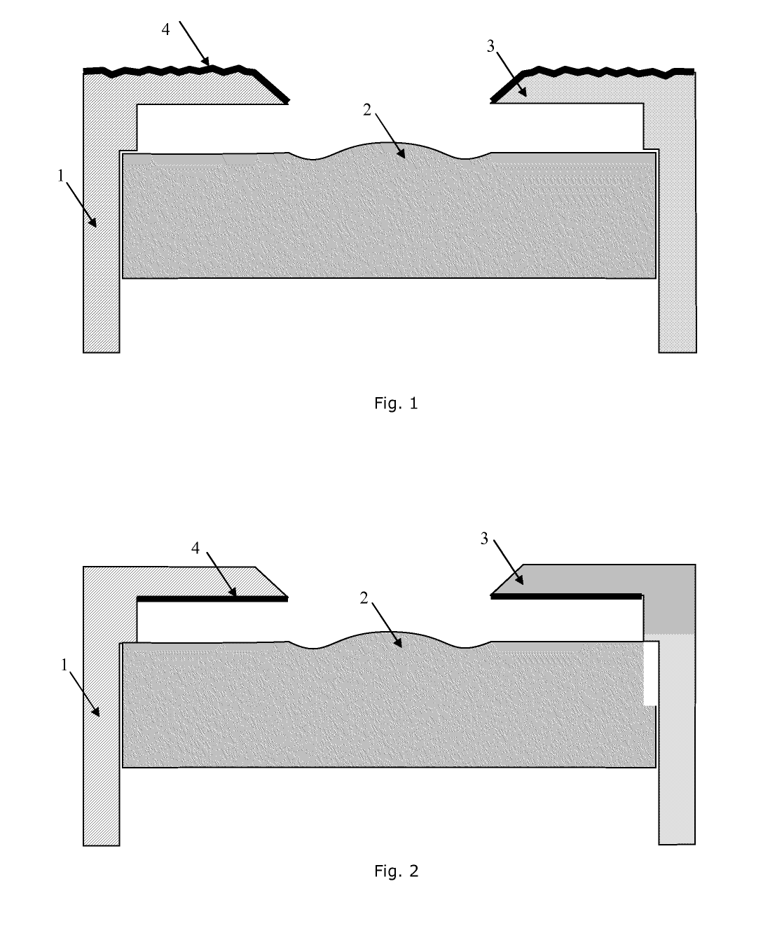

Example 1, illustrated in FIG. 1, shows an aperture stop metalized on its object-side. A patterned surface is schematically represented.

Example 2, illustrated in FIG. 2, shows an aperture stop metalized on its detector-side.

Are shown: the housing (1) of the assembly, containing one lens (2), the housing also structurally defining a frontal (object-side) aperture stop (3). This structure serves as a support for a metallic diaphragm (4), located either on the object-side surface of the stop (FIG. 1) or on its detector-side surface (FIG. 2).

1-5. (canceled)

6. An IR imaging system comprising an optical assembly comprising a lens housing made of an organic polymer, wherein the housing structurally defines a frontal aperture stop comprising an object-side surface and a. detector-side surface, and wherein the aperture stop further comprises a metallic diaphragm.

7. The IR imaging system according to claim 6, wherein the diaphragm comprises a metallic layer on the organic polymer defining the aperture stop, either on its object-side surface or on its detector-side surface.

8. The IR imaging system according to claim 6, wherein the metallic diaphragm is embedded in the organic polymer.

9. The IR imaging system according to claim 6, further comprising an essentially flat IR-transparent window in front of the optical assembly as a protective screen.

10. The IR imaging system according to claim 9, wherein the metallic diaphragm is patterned on at least its object-side surface so as to attenuate specular reflections.
